(19) United States
(12) Patent Application Publication
(10) Pub. No.: US 2014/0353856 A1
(43) Pub. Date: Dec. 4, 2014

(54) AEROSOL GENERATING DEVICE WITH ADJUSTABLE AIRFLOW

(71) Applicant: Philip Morris Products S.A., Neuchatel (CH)

(72) Inventor: Flavien Dubief, Neuchatel (CH)

(73) Assignee: Philip Morris Products S.A., Neuchatel (CH)

(21) Appl. No.: 14/363,513

(22) PCT Filed: Dec. 5, 2012
(86) PCT No.: PCT/EP12/74516

§ 371 Date: Jun. 6, 2014

(30) Foreign Application Priority Data
Dec. 8, 2011 (EP) 11192695.2

(51) Int. Cl. B01F 15/06; A24F 47/00; B01F 3/04

(52) U.S. Cl. CPC B01F 15/06; B01F 3/04014; B01F 3/04078; A24F 47/008; B01F 2015/062
USPC 261/128; 261/137

(57) ABSTRACT

There is provided an aerosol generating system configured to heat an aerosol-forming substrate, the system including an aerosol generating device and a cartridge, a vaporizer configured to heat the aerosol-forming substrate to form an aerosol, at least one air inlet and at least one air outlet. The air inlet and the air outlet are arranged so as to define an air flow route between the air inlet and the air outlet. The aerosol generating system further includes a flow control configured to adjust a size of the at least one air inlet, so as to control an air flow speed in the air flow route.

The present invention relates to an aerosol generating device for heating an aerosol-forming substrate. Particularly, but not exclusively, the present invention relates to an electrically operated aerosol generating device for heating a liquid aerosol-forming substrate.

WO-A-2009/132793 discloses an electrically heated smoking system. A liquid is stored in a liquid storage portion, and a capillary wick has a first end which extends into the liquid storage portion for contact with the liquid therein, and a second end which extends out of the liquid storage portion. A heating element heats the second end of the capillary wick. The heating element is in the form of a spirally wound electric heating element in electrical connection with a power supply, and surrounding the second end of the capillary wick. In use, the heating element may be activated by the user to switch on the power supply. Suction on a mouthpiece by the user causes air to be drawn into the electrically heated smoking system over the capillary wick and heating element and subsequently into the mouth of the user.

It is an object of the present invention to improve the generation of aerosol in an aerosol generation device or system.

According to one aspect of the invention, there is provided an aerosol generating system comprising an aerosol generating device in cooperation with a cartridge, the system comprising: a vaporizer for heating an aerosol-forming substrate; at least one air inlet; at least one air outlet, the air inlet and the air outlet being arranged to define an air flow route between the air inlet and the air outlet; and flow control means for adjusting the size of the at least one air inlet, so as to control the air flow speed in the air flow route.

The aerosol generating system, comprising the aerosol generating device and cartridge, is arranged to heat the aerosol-forming substrate to form the aerosol. The cartridge or aerosol generating device may include the aerosol-forming substrate or may be adapted to receive the aerosol-forming substrate. As known to those skilled in the art, an aerosol is a suspension of solid particles or liquid droplets in a gas, such as air. The aerosol generating system may further comprise an aerosol forming chamber in the air flow route between the at least one air inlet and the at least one air outlet. The aerosol forming chamber may assist or facilitate the generation of the aerosol.

The flow control means allows the pressure drop at the air inlet to be adjusted. This affects the speed of the air flow through the aerosol generating device and cartridge. The air flow speed affects the mean droplet size and the droplet size distribution in the aerosol, which may in turn affect the experience for the user. Thus, the flow control means is advantageous for a number of reasons. First, the flow control means allows the resistance to draw (that is pressure drop at the air inlet) to be adjusted, for example according to user preference. Second, for a given aerosol-forming substrate, the flow control means allows a range of mean aerosol droplet sizes to be produced. The flow control means may be operable by a user to create an aerosol having droplet size characteristics which suit the user's preference. Third, the flow control means allows a particular desired mean aerosol droplet size to be produced for a selection of aerosol-forming substrates. Thus, the flow control means allows the aerosol generating device and cartridge to be compatible with a variety of different aerosol-forming substrates.

Moreover, the air flow speed may also affect how much condensation forms within the aerosol generating device and cartridge, particularly within the aerosol forming chamber. Condensation may adversely affect liquid leakage from the aerosol generating device and cartridge. Thus, a further advantage of the flow control means is that it can be used to reduce liquid leakage. The distribution and mean of the droplet size in the aerosol may also affect the appearance of any smoke. So, fourth, the flow control means may be used to adjust the appearance of any smoke from the aerosol generating device and cartridge, for example according to user preference or according to the particular environment in which the aerosol generating system is being used.

Preferably, the flow control means is user operable. Thus, the user may select the size of the at least one air inlet. This results in affecting the mean droplet size and droplet size distribution. The desired aerosol may be selected by the user for a particular aerosol-forming substrate or for a selection of aerosol-forming substrates usable with the aerosol generating device and cartridge. Alternatively, the flow control means may be operable by a manufacturer to select one desired size for the at least one air inlet.

In a preferred embodiment, the flow control means comprises: a first member and a second member, the first and second members cooperating to define the at least one air inlet, wherein the first and second members are arranged to move relative to one another so as to vary the size of the at least one air inlet.

Preferably, the two members are sheet-like. The sheet-like members may be planar or curved. Preferably, the two planar members move relative to one another by sliding over one another. Alternatively, the two planar members may move relative to one another along a thread, for example a screw thread.

Preferably, the aerosol generating device comprises one of the first member and the second member, and the cartridge comprises the other of the first member and the second member. The aerosol generating device and cartridge may each comprise a housing. Preferably, the first member and the second member form part of the housing of each of the device and cartridge. The cartridge may comprise a mouthpiece. The housing may comprise any suitable material or combination of materials. Examples of suitable materials include metals, alloys, plastics or composite materials containing one or more of those materials, or thermoplastics that are suitable for food or pharmaceutical applications, for example polypropylene, polyetheretherketone (PEEK) and polyethylene. Preferably, the material is light and non-brittle.

The first member may include an aperture. The second member may include an aperture. Preferably, the first member comprises at least one first aperture and the second member comprises at least one second aperture; the first and second apertures together forming the at least one air inlet; and wherein the first and second members are arranged to move relative to one another so as to vary the extent of overlap of the first aperture and the second aperture so as to vary the size of the at least one air inlet.

If there is very little overlap between the first aperture and the second aperture, the resulting air inlet will have a small cross sectional area. If there is a large amount of overlap between the first aperture and the second aperture, the resulting air inlet will have a large cross sectional area. The first aperture may have any suitable shape. The second aperture may have any suitable shape. The shapes of the first aperture and the second aperture may be the same or different. Any number of apertures may be provided on the first member and on the second member. The number of apertures on the first member may be different from the number of apertures on the second member. Alternatively, the number of apertures on the first member may be the same as the number of apertures on the second member. In that case, each aperture on the first member may align with a respective aperture on the second member to form an air inlet. Thus, the number of air inlets may be the same as the number of apertures on each of the first and second members. Additional air inlets may be provided having a fixed cross sectional area, which are not adjustable by the flow control means.

In one embodiment, the first member and the second member are rotatably moveable relative to one another. In one embodiment, the first member and the second member are linearly moveable relative to one another. In one embodiment, the first member and the second member rotate relative to one another, in order to vary the size of the at least one air inlet; no linear movement is involved. In another embodiment, the first member and the second member move linearly relative to one another, in order to vary the size of the at least one air inlet; there is no rotation. However, in another embodiment, the first member and the second member rotate and move linearly relative to one another, for example, by a screw thread. For example, if the first and second members form part of the housings of the aerosol generating device and cartridge, the first and second members may be connectable by a screw thread to assemble the aerosol generating system. The screw thread may also allow the first and second members to move relative to one another, thereby providing the flow control means.

Preferably, the cartridge includes the first member and the aerosol generating device includes the second member. In a preferred embodiment, the cartridge comprises a housing having a first sleeve comprising the first member and including at least one first aperture and the aerosol generating device comprises a housing having a second sleeve comprising the second member and including at least one second aperture, wherein the at least one first aperture and the at least one second aperture together form the at least one air inlet, and wherein the first sleeve and the second sleeve are rotatable relative to one other so as to vary the extent of overlap of the first aperture and the second aperture so as to vary the cross sectional area of the air inlet. One of the first sleeve and the second sleeve may be an outer sleeve, and the other of the first sleeve and the second sleeve may be an inner sleeve.

The flow control means is for adjusting the size of the at least one air inlet. This allows the air flow speed in the air flow route to be varied. Additionally, the at least one air outlet may be adjustable in size. This may allow the resistance to draw to be varied, for example according to user preference.

The at least one air inlet may form part of the cartridge or part of the aerosol generating device. If there is more than one air inlet, one or more of the air inlets may form part of the cartridge and one or more other of the air inlets may form part of the aerosol generating device. The flow control means may form part of the cartridge or the device. Alternatively, the flow control means may be formed by cooperation between part of the cartridge and part of the device. If the flow control means comprises a first member and a second member, both the first and second members may be contained in the cartridge, or both the first and second members may be contained in the device, or one of the first and second members may be contained in the cartridge and the other of the first and second members may be contained in the device.

If the first and second members comprise outer and inner sleeves, the outer sleeve and inner sleeve may form part of the device, or the outer sleeve and the inner sleeve may form part of the cartridge, or one of the outer sleeve and the inner sleeve may form part of the device and the other of the outer sleeve and the inner sleeve may form part of the cartridge.

The aerosol-forming substrate is capable of releasing volatile compounds that can form an aerosol. The volatile compounds may be released by heating the aerosol forming substrate or may be released by a chemical reaction or by a mechanical stimulus. The aerosol-forming substrate may contain nicotine. The aerosol-forming substrate may be a solid aerosol-forming substrate. The aerosol-forming substrate preferably comprises a tobacco-containing material containing volatile tobacco flavour compounds which are released from the substrate upon heating. The aerosol-forming substrate may comprise a non-tobacco material. The aerosol-forming substrate may comprise tobacco-containing material and non-tobacco containing material. Preferably, the aerosol-forming substrate further comprises an aerosol former. Examples of suitable aerosol formers are glycerine and propylene glycol.

However, in a preferred embodiment, the aerosol-forming substrate is a liquid aerosol-forming substrate. The liquid aerosol-forming substrate preferably has physical properties, for example boiling point and vapour pressure, suitable for use in the aerosol generating device and cartridge. If the boiling point is too high, it may not be possible to heat the liquid but, if the boiling point is too low, the liquid may heat too readily. The liquid preferably comprises a tobacco-containing material comprising volatile tobacco flavour compounds which are released from the liquid upon heating. Alternatively, or in addition, the liquid may comprise a non-tobacco material. The liquid may include aqueous solutions, non-aqueous solvents such as ethanol, plant extracts, nicotine, natural or artificial flavours or any combination of these. Preferably, the liquid further comprises an aerosol former that facilitates the formation of a dense and stable aerosol. Examples of suitable aerosol formers are glycerine and propylene glycol.

If the aerosol-forming substrate is a liquid substrate, the aerosol generating system may further comprise a storage portion for storing the liquid aerosol-forming substrate. Preferably, the liquid storage portion is provided in the cartridge. An advantage of providing a storage portion is that the liquid in the liquid storage portion is protected from ambient air (because air cannot generally enter the liquid storage portion) and, in some embodiments light, so that the risk of degradation of the liquid is significantly reduced. Moreover, a high level of hygiene can be maintained. The liquid storage portion may not be refillable. Thus, when the liquid in the liquid storage portion has been used up, the aerosol generating system or cartridge is replaced. Alternatively, the liquid storage portion may be refillable. In that case, the aerosol generating system or cartridge may be replaced after a certain number of refills of the liquid storage portion. Preferably, the liquid storage portion is arranged to hold liquid for a pre-determined number of puffs.

The aerosol-forming substrate may alternatively be any other sort of substrate, for example, a gas substrate, a gel substrate or any combination of the various types of substrate.

If the aerosol-forming substrate is a liquid aerosol-forming substrate, the vaporizer of the aerosol generating system may comprise a capillary wick for conveying the liquid aerosol-forming substrate by capillary action. The capillary wick may be provided in the aerosol generating device or in the cartridge, but preferably, the capillary wick is provided in the cartridge. Preferably, the capillary wick is arranged to be in contact with liquid in the liquid storage portion. Preferably, the capillary wick extends into the liquid storage portion. In that case, in use, liquid is transferred from the liquid storage portion by capillary action in the capillary wick. In one embodiment, liquid in one end of the capillary wick is vaporized by the heater to form a supersaturated vapour. The supersaturated vapour is mixed with and carried in the air flow. During the flow, the vapour condenses to form the aerosol and the aerosol is carried towards the mouth of a user. The liquid aerosol-forming substrate has suitable physical properties, including surface tension and viscosity, which allow the liquid to be transported through the capillary wick by capillary action.

The capillary wick may have a fibrous or spongy structure. The capillary wick preferably comprises a bundle of capillaries. For example, the capillary wick may comprise a plurality of fibres or threads or other fine bore tubes. The fibres or threads may be generally aligned in the longitudinal direction of the aerosol generating system. Alternatively, the capillary wick may comprise sponge-like or foam-like material formed into a rod shape. The rod shape may extend along the longitudinal direction of the aerosol generating system. The structure of the wick forms a plurality of small bores or tubes, through which the liquid can be transported by capillary action. The capillary wick may comprise any suitable material or combination of materials. Examples of suitable materials are capillary materials, for example a sponge or foam material, ceramic- or graphite-based materials in the form of fibres or sintered powders, foamed metal or plastics material, a fibrous material, for example made of spun or extruded fibres, such as cellulose acetate, polyester, or bonded polyolefin, polyethylene, terylene or polypropylene fibres, nylon fibres or ceramic. The capillary wick may have any suitable capillarity and porosity so as to be used with different liquid physical properties. The liquid has physical properties, including but not limited to viscosity, surface tension, density, thermal conductivity, boiling point and vapour pressure, which allow the liquid to be transported through the capillary device by capillary action. The capillary wick must be suitable so that the required amount of liquid can be delivered to the vaporizer.

Alternatively, instead of a capillary wick, the aerosol generating system may comprise any suitable capillary or porous interface between the liquid aerosol-forming substrate and the vaporizer, for conveying the desired amount of liquid to the vaporizer. The capillary or porous interface may be provided in the cartridge or in the device, but preferably, the capillary or porous interface is provided in the cartridge. The aerosol-forming substrate may be adsorbed, coated, impregnated of otherwise loaded onto any suitable carrier or support.

Preferably, but not necessarily, the capillary wick or capillary or porous interface is contained in the same portion as the liquid storage portion.

The vaporiser may be a heater. The heater may heat the aerosol-forming substrate means by one or more of conduction, convection and radiation. The heater may be an electric heater powered by an electric power supply. The heater may alternatively be powered by a non-electric power supply, such as a combustible fuel: for example, the heater may comprise a thermally conductive element that is heated by combustion of a gas fuel. The heater may heat the aerosol-forming substrate by means of conduction and may be at least partially in contact with the substrate, or a carrier on which the substrate is deposited. Alternatively, the heat from the heater may be conducted to the substrate by means of an intermediate heat conductive element. Alternatively, the heater may transfer heat to the incoming ambient air that is drawn through the aerosol-generating system during use, which in turn heats the aerosol-forming substrate by convection. In a preferred embodiment, the aerosol generating system is electrically operated and the vaporizer of the aerosol generating system comprises an electric heater for heating the aerosol-forming substrate.

The electric heater may comprise a single heating element. Alternatively, the electric heater may comprise more than one heating element for example two, or three, or four, or five, or six or more heating elements. The heating element or heating elements may be arranged appropriately so as to most effectively heat the aerosol-forming substrate.

The at least one electric heating element preferably comprises an electrically resistive material. Suitable electrically resistive materials include but are not limited to: semiconductors such as doped ceramics, electrically “conductive” ceramics (such as, for example, molybdenum disilicide), carbon, graphite, metals, metal alloys and composite materials made of a ceramic material and a metallic material. Such composite materials may comprise doped or undoped ceramics. Examples of suitable doped ceramics include doped silicon carbides. Examples of suitable metals include titanium, zirconium, tantalum and metals from the platinum group. Examples of suitable metal alloys include stainless steel, Constantan, nickel-, cobalt-, chromium-, aluminium- titanium- zirconium-, hafnium-, niobium-, molybdenum-, tantalum-, tungsten-, tin-, gallium-, manganese- and iron-containing alloys, and super-alloys based on nickel, iron, cobalt, stainless steel, Timetal®, iron-aluminium based alloys and iron-manganese-aluminium based alloys. Timetal® is a registered trade mark of Titanium Metals Corporation, 1999 Broadway Suite 4300, Denver Colo. In composite materials, the electrically resistive material may optionally be embedded in, encapsulated or coated with an insulating material or vice-versa, depending on the kinetics of energy transfer and the external physicochemical properties required. The heating element may comprise a metallic etched foil insulated between two layers of an inert material. In that case, the inert material may comprise Kapton®, all-polyimide or mica foil. Kapton® is a registered trade mark of E.I. du Pont de Nemours and Company, 1007 Market Street, Wilmington, Del. 19898, United States of America.

Alternatively, the at least one electric heating element may comprise an infra-red heating element, a photonic source or an inductive heating element.

The at least one electric heating element may take any suitable form. For example, the at least one electric heating element may take the form of a heating blade. Alternatively, the at least one electric heating element may take the form of a casing or substrate having different electro-conductive portions, or an electrically resistive metallic tube. The liquid storage portion may incorporate a disposable heating element. Alternatively, if the aerosol-forming substrate is liquid, one or more heating needles or rods that run through the liquid aerosol-forming substrate may also be suitable. Alternatively, the at least one electric heating element may be a disk (end) heater or a combination of a disk heater with heating needles or rods. Alternatively, the at least one electric heating element may comprise a flexible sheet of material. Other alternatives include a heating wire or filament, for example a nickel-chromium (Ni—Cr), platinum, tungsten or alloy wire, or a heating plate. Optionally, the heating element may be deposited in or on a rigid carrier material.

The at least one electric heating element may comprise a heat sink, or heat reservoir comprising a material capable of absorbing and storing heat and subsequently releasing the heat over time to heat the aerosol-forming substrate. The heat sink may be formed of any suitable material, such as a suitable metal or ceramic material. Preferably, the material has a high heat capacity (sensible heat storage material), or is a material capable of absorbing and subsequently releasing heat via a reversible process, such as a high temperature phase change. Suitable sensible heat storage materials include silica gel, alumina, carbon, glass mat, glass fibre, minerals, a metal or alloy such as aluminium, silver or lead, and a cellulose material. Other suitable materials which release heat via a reversible phase change include paraffin, sodium acetate, naphthalene, wax, polyethylene oxide, a metal, metal salt, a mixture of eutectic salts or an alloy.

The heat sink may be arranged such that it is directly in contact with the aerosol-forming substrate and can transfer the stored heat directly to the substrate. Alternatively, the heat stored in the heat sink or heat reservoir may be transferred to the aerosol-forming substrate by means of a heat conductor, such as a metallic tube.

The at least one heating element may heat the aerosol-forming substrate by means of conduction. The heating element may be at least partially in contact with the substrate. Alternatively, the heat from the heating element may be conducted to the substrate by means of a heat conductor.

Alternatively, the at least one heating element may transfer heat to the incoming ambient air that is drawn through the aerosol generating device and cartridge during use, which in turn heats the aerosol-forming substrate by convection. The ambient air may be heated before passing through the aerosol-forming substrate. Alternatively, the ambient air may be first drawn through the liquid substrate and then heated.

The electric heater may be contained in the device or in the cartridge. Preferably, but not necessarily, the electric heater is contained in the same portion as the capillary wick.

In one preferred embodiment, the aerosol-forming substrate is a liquid aerosol-forming substrate, the aerosol generating system comprises a storage portion for storing the liquid aerosol-forming substrate, and the vaporizer of the aerosol generating system comprises an electric heater and a capillary wick. In that embodiment, preferably the capillary wick is arranged to be in contact with liquid in the liquid storage portion. In use, liquid is transferred from the liquid storage portion towards the electric heater by capillary action in the capillary wick. In one embodiment, the capillary wick has a first end and a second end, the first end extending into the liquid storage portion for contact with liquid therein and the electric heater being arranged to heat liquid in the second end. In another embodiment, the capillary wick may lay along the edge of the liquid storage portion. When the heater is activated, the liquid at the second end of the capillary wick is vaporized by the heater to form the supersaturated vapour. The supersaturated vapour is mixed with and carried in the air flow. During the flow, the vapour condenses to form the aerosol and the aerosol is carried towards the mouth of a user.

However, the invention is not limited to heater vaporizers but may be used in aerosol generating systems in which the vapour and resulting aerosol is generated by a mechanical vaporizer, for example but not limited to a piezo vaporizer or an atomizer using pressurized liquid.

The liquid storage portion, and optionally the capillary wick and the heater, may be removable from the aerosol generating system as a single component. For example, the liquid storage portion, capillary wick and heater may be contained in the cartridge.

The aerosol generating system may be electrically operated and may further comprise an electric power supply. The electric power supply may be contained in the cartridge or in the aerosol generating device. Preferably, the electric power supply is contained in the aerosol generating device. The electric power supply may be an AC power source or a DC power source. Preferably, the electric power supply is a battery.

The aerosol generating system may further comprise electric circuitry. In one embodiment, the electric circuitry comprises a sensor to detect air flow indicative of a user taking a puff. In that case, preferably, the electric circuitry is arranged to provide an electric current pulse to the electric heater when the sensor senses a user taking a puff. Preferably, the time-period of the electric current pulse is pre-set, depending on the amount of aerosol-forming substrate desired to be vaporized. The electric circuitry is preferably programmable for this purpose. Alternatively, the electric circuitry may comprise a manually operable switch for a user to initiate a puff. The time-period of the electric current pulse is preferably pre-set depending on the amount of aerosol-forming substrate desired to be vaporized. The electric circuitry is preferably programmable for this purpose. The electric circuitry may be contained in the cartridge or in the device. Preferably, the electric circuitry is contained in the device.

If the aerosol generating system includes a housing, preferably the housing is elongate. If the aerosol generating system includes a capillary wick, the longitudinal axis of the capillary wick and the longitudinal axis of the housing may be substantially parallel. The housing may comprise a housing portion for the aerosol generating device and a housing portion for the cartridge. In that case, all the components may be contained in either housing portion. In one embodiment, the housing includes a removable insert comprising the liquid storage portion, the capillary wick and the heater. In that embodiment, those parts of the aerosol generating system may be removable from the housing as a single component. This may be useful for refilling or replacing the liquid storage portion, for example.

In one particularly preferred embodiment, the aerosol-forming substrate is a liquid aerosol-forming substrate, and the aerosol generating system further comprises: a housing comprising an inner sleeve having at least one inner aperture and an outer sleeve having at least one outer aperture, the inner and outer apertures together forming the at least one air inlet; an electric power supply and electric circuitry arranged in the aerosol generating device; and a storage portion for holding the liquid aerosol-forming substrate; wherein the vaporizer comprises a capillary wick for conveying the liquid aerosol-forming substrate from the liquid storage portion, the capillary wick having a first end extending into the liquid storage portion and a second end opposite the first end, and an electric heater, connected to the electric power supply, for heating the liquid aerosol-forming substrate in the second end of the capillary wick; wherein the liquid storage portion, capillary wick and electric heater are arranged in the cartridge of the aerosol generating system; and wherein the flow control means comprises the inner sleeve and the outer sleeve of the housing, the inner and outer sleeves being arranged to move relative to one another so as to vary the extent of overlap of the inner aperture and the outer aperture so as to vary the size of the at least one air inlet.

Preferably, the aerosol generating device and cartridge are portable, both individually and in cooperation. Preferably, the device is reusable by a user. Preferably, the cartridge is disposable by a user, for example when there is no more liquid contained in the liquid storage portion. The aerosol generating device and cartridge may cooperate to form an aerosol generating system which is a smoking system and which may have a size comparable to a conventional cigar or cigarette. The smoking system may have a total length between approximately 30 mm and approximately 150 mm. The smoking system may have an external diameter between approximately 5 mm and approximately 30 mm.

Preferably, the aerosol generating system is an electrically operated smoking system.

According to the invention, there is also provided an aerosol generating system for heating an aerosol-forming substrate, the system comprising: a vaporizer for heating the aerosol-forming substrate to form an aerosol; at least one air inlet; at least one air outlet, the air inlet and the air outlet being arranged to define an air flow route between the air inlet and the air outlet; and flow control means for adjusting the size of the at least one air inlet, so as to control the air flow speed in the air flow route.

According to another aspect of the invention, there is provided a cartridge comprising: a storage portion a storage portion for storing an aerosol-forming substrate; a vaporizer for heating the aerosol-forming substrate; at least one air inlet; at least one air outlet, the air inlet and the air outlet being arranged to define an air flow route between the air inlet and the air outlet; and wherein the cartridge comprises flow control means for adjusting the size of the at least one air inlet, so as to control the air flow speed in the air flow route.

According to another aspect of the invention, there is provided an aerosol generating device for heating an aerosol-forming substrate comprising a storage portion for storing an aerosol-forming substrate; a vaporizer for heating the aerosol-forming substrate; at least one air inlet; at least one air outlet, the air inlet and the air outlet being arranged to define an air flow route between the air inlet and the air outlet; and wherein the device comprise flow control means for adjusting the size of the at least one air inlet, so as to control the air flow speed in the air flow route.

For all aspects of the invention, the storage portion may be a liquid storage portion. For all aspects of the invention, the aerosol forming substrate may be a liquid aerosol forming substrate.

The aerosol-forming substrate may alternatively be any other sort of substrate, for example, a gas substrate or a gel substrate, or any combination of the various types of substrate.

The at least one air outlet may be provided only in the cartridge. Alternatively, the at least one air outlet may be provided only in the aerosol generating device. Alternatively, at least one air outlet may be provided in the cartridge and at least one air outlet may be provided in the aerosol generating device. The at least one air inlet may be provided only in the cartridge. Alternatively, the at least one air inlet may be provided only in the aerosol generating device. Alternatively, at least one air inlet may be provided in the cartridge and at least one air inlet may be provided in the aerosol generating device. For example, the at least one air inlet in the cartridge and the at least one air inlet in the aerosol generating device may be arranged to align or partially align when the cartridge is in use with the aerosol generating device.

The flow control means may be provided only in the cartridge. Alternatively, both the cartridge and the aerosol generating device may comprise flow control means. In that embodiment, preferably the cartridge and the aerosol generating device cooperate to form the flow control means. Alternatively, the cartridge may comprise first flow control means and the aerosol generating device may comprise second flow control means. In a preferred embodiment, the flow control means comprises: a first member of the cartridge and a second member of the aerosol generating device, the first and second members cooperating to define the at least one air inlet, wherein the first and second members are arranged to move relative to one another so as to vary the size of the at least one air inlet.

For example, if the cartridge comprises at least one air inlet and the aerosol generating device comprises at least one air inlet, the at least one air inlet in the cartridge and the at least one air inlet in the aerosol generating device may be arranged to align or partially align when the cartridge is in use with the aerosol generating device. The first member and the second member may be arranged to move relative to one another so as to vary the extent of overlap of the air inlet on the cartridge and the air inlet on the aerosol generating device. If there is very little overlap between the two air inlets, the resulting air inlet will have a small cross sectional area. This will increase the speed of the air flow in the aerosol generating device. If there is a large amount of overlap between the two air inlets, the resulting air inlet will have a large cross sectional area. This will decrease the speed of the air flow in the aerosol generating device.

Preferably, the vaporizer comprises a capillary wick for conveying the liquid aerosol-forming substrate by capillary action. The properties of such a capillary wick have already been discussed. Alternatively, instead of a capillary wick, the vaporizer may comprise any suitable capillary or porous interface for conveying the desired amount of liquid to be vaporized.

Preferably, the aerosol generating device is electrically operated and the vaporizer comprises an electric heater for heating the liquid aerosol-forming substrate, the electric heater being connectable to an electric power supply in the aerosol generating device. The properties of such an electric heater have already been discussed.

In a preferred embodiment, the vaporizer of the cartridge comprises an electric heater and a capillary wick. In that embodiment, preferably the capillary wick is arranged to be in contact with liquid in the storage portion. In use, liquid is transferred from the storage portion towards the electric heater by capillary action in the capillary wick. In one embodiment, the capillary wick has a first end and a second end, the first end extending into the storage portion for contact with liquid therein and the electric heater being arranged to heat liquid in the second end. When the heater is activated, the liquid at the second end of the capillary wick is vaporized by the heater to form the supersaturated vapour.

According to another aspect of the invention, there is provided a method for varying air flow speed in an aerosol generating system comprising an aerosol generating device in cooperation with a cartridge, the aerosol generating system comprising a vaporizer for heating an aerosol-forming substrate to form an aerosol, at least one air inlet, and at least one air outlet, the air inlet and the air outlet being arranged to define an air flow route between the air inlet and the air outlet, the method comprising: adjusting the size of the at least one air inlet, so as to vary the air flow speed in the air flow route.

Adjusting the size of the at least one air inlet varies the pressure drop at the air inlet. This affects the speed of the air flow through the aerosol generating system and the resistance to draw. The air flow speed affects the mean droplet size and the droplet size distribution in the aerosol, which may in turn affect the experience for the user.

In one embodiment, the aerosol generating system comprises a first member and a second member, the first and second members cooperating to define the at least one air inlet, and wherein the step of adjusting the size of the at least one air inlet comprises moving the first and second members relative to one another so as to vary the size of the at least one air inlet. One of the first and second members may be provided in the aerosol generating device, and the other of the first and second members may be provided in the cartridge.

Features described in relation to one aspect of the invention may be applicable to another aspect of the invention. In particular, features described in relation to the aerosol generating device may also be applicable to the cartridge.

The invention will be further described, by way of example only, with reference to the accompanying drawings, of which:

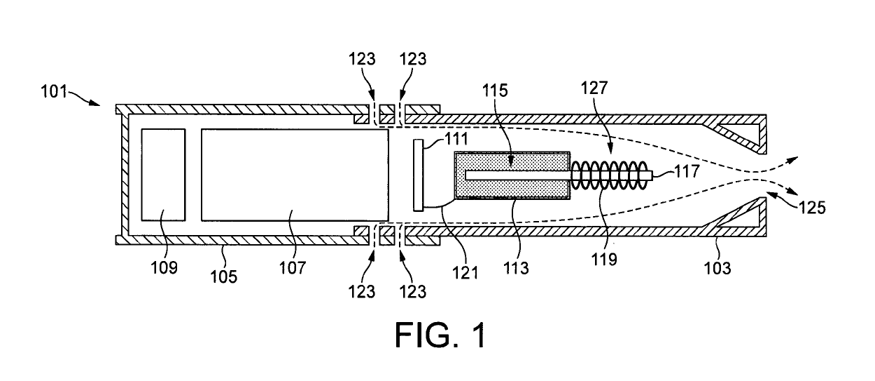

FIG. 1 shows an embodiment of an aerosol generating system according to the invention;

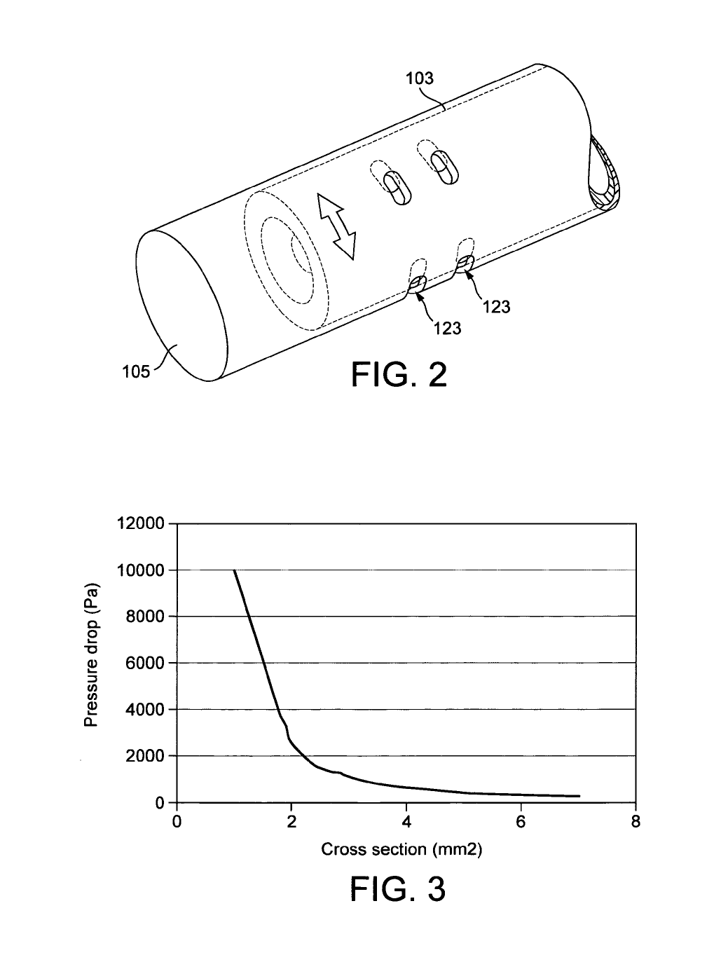

FIG. 2 is a perspective view of a portion of an aerosol generating system according to the invention, showing the air inlets in more detail;

FIG. 3 is a graph showing resistance to draw as a function of airflow path cross section in an aerosol generating system;

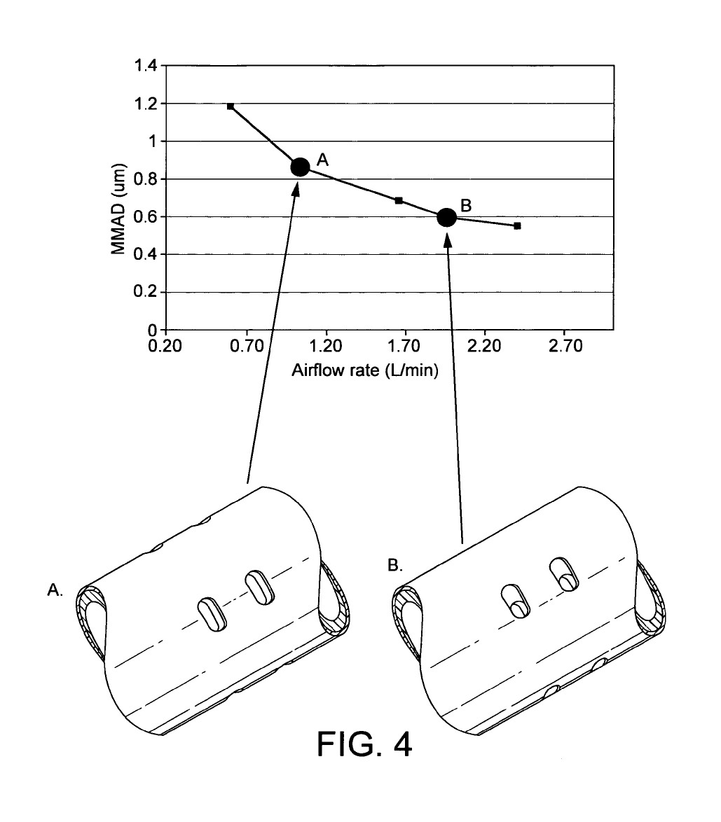

FIG. 4 is a graph showing the effect of air flow rate on aerosol droplet size for a given aerosol-forming substrate in an aerosol generating system; and

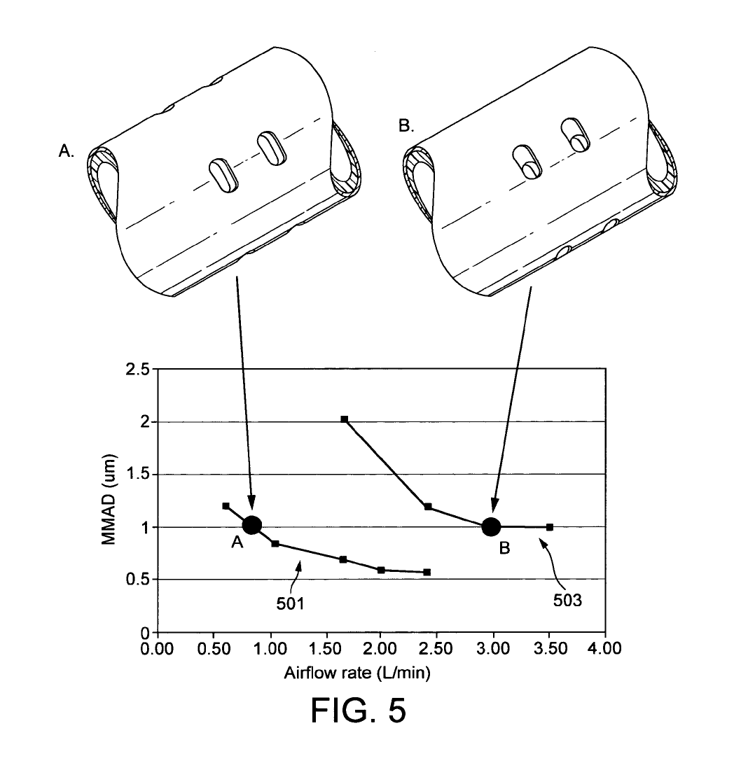

FIG. 5 is a graph showing the effect of air flow rate on aerosol droplet size for two alternative aerosol-forming substrates in an aerosol generating system.

FIG. 1 shows one example of an aerosol generating system according to the invention. In FIG. 1, the system is an electrically operated smoking system having a storage portion. The smoking system 101 of FIG. 1 comprises a cartridge 103 and a device 105. In the device 105, there is provided an electric power supply in the form of battery 107 and electric circuitry in the form of hardware 109 and puff detection system 111. In the cartridge 103, there is provided a storage portion 113 containing liquid 115, a capillary wick 117 and a vaporizer in the form of heater 119. Note that the heater is only shown schematically in FIG. 1. In the exemplary embodiment shown in FIG. 1, one end of capillary wick 117 extends into liquid storage portion 113 and the other end of capillary wick 117 is surrounded by the heater 119. The heater is connected to the electric circuitry via connections 121, which may pass along the outside of liquid storage portion 113 (not shown in FIG. 1). The cartridge 103 and the device 105 each include apertures which, when the cartridge and device are assembled together, align to form air inlets 123. Flow control means (to be described further with reference to FIGS. 2 to 5) are provided, allowing the size of the air inlets 123 to be adjusted. The cartridge 103 further includes an air outlet 125, and an aerosol forming chamber 127. The air flow route from the air inlets 123 through the aerosol forming chamber 127 to the air outlet 125 is shown by the dotted arrows.

In use, operation is as follows. Liquid 115 is conveyed by capillary action from the liquid storage portion 113 from the end of the wick 117 which extends into the liquid storage portion to the other end of the wick which is surrounded by heater 119. When a user draws on the aerosol generating system at the air outlet 125, ambient air is drawn through air inlets 123 as shown by the dotted arrows. In the arrangement shown in FIG. 1, the puff detection system 111 senses the puff and activates the heater 119. The battery 107 supplies electrical energy to the heater 119 to heat the end of the wick 117 surrounded by the heater. The liquid in that end of the wick 117 is vaporized by the heater 119 to create a supersaturated vapour. At the same time, the liquid being vaporized is replaced by further liquid moving along the wick 117 by capillary action. (This is sometimes referred to as “pumping action”.) The supersaturated vapour created is mixed with and carried in the air flow from the air inlets 123. In the aerosol forming chamber 127, the vapour condenses to form an inhalable aerosol, which is carried towards the outlet 125 and into the mouth of the user.

In the embodiment shown in FIG. 1, the hardware 109 and puff detection system 111 are preferably programmable. The hardware 109 and puff detection system 111 can be used to manage the aerosol generating system operation.

FIG. 1 shows one example of an aerosol generating system according to the present invention. Many other examples are possible, however. The aerosol generating system simply needs to comprise an aerosol generating device and a cartridge and to include a vaporizer for heating the aerosol-forming substrate to form an aerosol, at least one air inlet, at least one air outlet, and flow control means (to be described below with reference to FIGS. 2 to 5) for adjusting the size of the at least one air inlet so as to control the air flow speed in the air flow route from the air inlet to the air outlet. For example, the system need not be electrically operated. For example, the system need not be a smoking system. For example, the aerosol-forming substrate need not be a liquid aerosol-forming substrate. Moreover, even if the aerosol-forming substrate is a liquid aerosol-forming substrate, the system may not include a capillary wick. In that case, the system may include another mechanism for delivering liquid for vaporization. In addition, the system may not include a heater, in which case another device may be included to heat the aerosol-forming substrate. For example, a puff detection system need not be provided. Instead, the system could operate by manual activation, for example the user operating a switch when a puff is taken. For example, the overall shape and size of the aerosol generating system could be altered.

As discussed above, according to the invention, the aerosol generating system includes flow control means for adjusting the size of the at least one air inlet, so as to control the air flow speed in the air flow route through the aerosol generating system. An embodiment of the invention, including the flow control means, will now be described with reference to FIGS. 2 to 5. The embodiment is based on the example shown in FIG. 1, although is applicable to other embodiments of aerosol generating systems. Note that FIGS. 1 and 2 are schematic in nature. In particular, the components shown are not necessarily to scale either individually or relative to one another.

FIG. 2 is a perspective view of a portion of the aerosol generating system of FIG. 1, showing in more detail the air inlets 123. FIG. 2 shows the cartridge 103 of the aerosol generating system 101 assembled with the device 105 of the aerosol generating system 101. The cartridge 103 and the device 105 each include apertures which, when the cartridge and device are assembled together, align or partially align to form air inlets 123.

In use, the cartridge 103 and the device 105 may be rotated relative to one another as shown by the arrow. The extent of overlap of the sets of apertures in the cartridge 103 and in the device 105 defines the size of the air inlets 123. The size of the air inlets 123 influences the velocity of the air flow through the aerosol generating system 101, which, in turn, affects the droplet size in the aerosol. This will be described further with reference to FIGS. 3 to 5.

FIG. 3 is a graph showing resistance to draw (pressure drop in Pascals (Pa)) as a function of airflow path cross section (mm²) in an aerosol generating system. As can be seen in FIG. 3, the pressure drop increases as the airflow path cross section decreases. (Note that the relationship shown in FIG. 3 is for a given flow rate, which is a combination of the puff duration and the puff volume.) The relationship between the pressure drop dP and the air flow path cross sectional area S² follows an inverse parabolic relationship of the form dP=a/S², where a is a constant. Thus, rotating the device 105 and the cartridge 103 relative to one another to increase the size of the air inlets 123 in the aerosol generating system increases the cross sectional area of the air flow path, which decreases the pressure drop or resistance to draw. Rotating the device 105 and the cartridge 103 relative to one another to decrease the size of the air inlets 123 in the aerosol generating system decreases the cross sectional area of the air flow path, which increases the pressure drop or resistance to draw.

As already mentioned, the size of the air inlets 123 influences the velocity of the air flow through the aerosol generating system 101. This, in turn, affects the droplet size in the aerosol as will now be described. It is known in the art that increasing the cooling rate in an aerosol generating system decreases the mean droplet size in the resulting aerosol. The cooling rate is a combination of the temperature gradient between the vaporizer and the surrounding temperature and the velocity of the air flow local to the vaporizer. The temperature gradient is determined and fixed by the ambient conditions, so the cooling rate is primarily driven by the local airflow velocity through the aerosol generating system, in particular through the aerosol forming chamber in the locality of the vaporizer. Thus, adjusting the airflow velocity through the aerosol forming chamber of the aerosol generating system enables generation of different types of aerosols for a given aerosol-forming substrate.

FIG. 4 is a graph showing the effect of air flow rate (litres per minute) on aerosol droplet size (microns) for a given aerosol-forming substrate in an aerosol generating system. It can be seen from FIG. 4 that increasing the air flow rate through the aerosol generating system decreases the mean aerosol droplet size. In contrast, decreasing the air flow rate through the aerosol generating system increases the mean droplet size in the resulting aerosol.

Two points on the curve of FIG. 4, A and B, have been labelled. State A has a relatively low air flow rate through the aerosol generating system, resulting in a relatively large mean droplet size in the resulting aerosol. This corresponds to a relatively large cross sectional area of the air flow path, which results in a relatively low resistance to draw, and hence a relatively low air flow rate. Thus, state A corresponds to the device 105 and the cartridge 103 of the aerosol generating system (see FIGS. 1 and 2) being rotated relative to one another so as to result in a relatively large overlap between the apertures in the device 105 and the cartridge 103. This results in a relatively large air inlet 123, for example 100% of the maximum air inlet size. In contrast, state B has a relatively high air flow rate through the aerosol generating system, resulting in a relatively small mean droplet size in the resulting aerosol. This corresponds to a relatively small cross sectional area of the air flow path, which results in a relatively high resistance to draw and hence a relatively high air flow rate. Thus, state B corresponds to the device 105 and the cartridge 103 of the aerosol generating system being rotated relative to one another so as to result in a relatively small amount of overlap between the apertures in the device 105 and the cartridge 103. This results in a relatively small air inlet 123, for example 40% of the maximum air inlet size.

As shown in FIG. 4, the present invention allows the size of the at least one air inlet to be adjusted so as to control the air flow speed in the air flow route. This enables the generation of different sorts of aerosols (that is aerosols with different mean droplet sizes and droplet size distributions) for a given aerosol-forming substrate.

Alternatively, adjusting the airflow velocity through the aerosol forming chamber of the aerosol generating system allows a desired aerosol droplet size to be produced for a variety of aerosol-forming substrates. FIG. 5 is a graph showing the effect of air flow rate (litres per minute) on aerosol droplet size (microns) for two alternative aerosol-forming substrates 501, 503 in an aerosol generating system. As in FIG. 4, for both aerosol-forming substrates 501 and 503, increasing the air flow rate through the aerosol generating system decreases the mean aerosol droplet size and decreasing the air flow rate through the aerosol generating system increases the mean aerosol droplet size. For a given air flow rate, aerosol-forming substrate 501 results in a smaller mean aerosol droplet size than aerosol-forming substrate 503.

Two points A and B have been labelled in FIG. 5. A is on the curve for aerosol-forming substrate 501. B is on the curve for aerosol-forming substrate 503. At A and B the resulting mean aerosol droplet size is equal. For state A, because of the properties of aerosol-forming substrate 501, the air flow rate which results in that mean aerosol droplet size is relatively low. This corresponds to a relatively large cross sectional area of the air flow path, which results in a relatively low resistance to draw, and hence a relatively low air flow rate. Thus, state A corresponds to the device 105 and the cartridge 103 of the aerosol generating system (see FIGS. 1 and 2) being rotated relative to one another so as to result in a relatively large overlap between the apertures in the device 105 and the cartridge 103. This results in a relatively large air inlet 123, for example 100% of the maximum air inlet size. For state B, however, because of the properties of aerosol-forming substrate 503, the air flow rate which results in that mean aerosol droplet size is relatively high. This corresponds to a relatively small cross sectional area of the air flow path, which results in a relatively high resistance to draw, and hence a relatively high air flow rate. Thus, state B corresponds to the device 105 and the cartridge 103 of the aerosol generating system being rotated relative to one another so as to result in a relatively small overlap between the apertures in the device 105 and the cartridge 103. This results in a relatively small air inlet 123, for example 40% of the maximum air inlet size.

As shown in FIG. 5, the present invention allows the size of the at least one air inlet to be adjusted so as to control the air flow speed in the air flow route. This enables the generation of a desired aerosol (that is having the desired mean droplet size and droplet size distribution) for a variety of aerosol-forming substrates.

In the described embodiment, rotation of the device 105 and the cartridge 103 relative to one another provides flow control means which allows the pressure drop at the air inlets 123 to be adjusted. This affects the speed of the air flow through the aerosol generating system. The air flow speed affects the mean droplet size and the droplet size distribution in the aerosol, which may in turn affect the experience for the user. Thus, the flow control means allows the resistance to draw (that is pressure drop at the air inlet) to be adjusted, for example according to user preference. In addition, for a given aerosol-forming substrate, the flow control means allows a range of mean aerosol droplet sizes to be produced, and the desired aerosol may be selected by a user according to the user's preference. Also, the flow control means allows a particular desired mean aerosol droplet size to be produced for a selection of aerosol-forming substrates. Thus, the flow control means allows the aerosol generating system to be compatible with a variety of different aerosol-forming substrates and the flow control means allows the user to select the desired aerosol properties for a number of different compatible aerosol-forming substrates.

In FIG. 2, the flow control means is provided by rotation of the device 105 and the cartridge 103 of the aerosol generating system relative to one another. However, the flow control means need not be provided by cooperation of the two portions of the system. Flow control means may be provided in the device 105. Alternatively or additionally, flow control means may be provided in the cartridge 103. In fact, the aerosol generating system need not comprise a separate cartridge and device. In addition, in the FIG. 2 embodiment, the size of the air inlets 123 is adjusted by varying the extent of overlap of the apertures in the device 105 and in the cartridge 103. However, the flow control means need not be formed by overlap of two sets of apertures. The flow control means may be provided by any other suitable mechanism. For example, the flow control means may be provided by a single aperture having a moveable shutter to open and close the aperture. In addition, in the FIG. 2 embodiment, the device 105 and the cartridge 103 are rotatable relative to one another. However, alternatively, the device 105 and the cartridge 103 could be linearly moveable relative to one another, for example, by sliding. Alternatively, the device 105 and the cartridge 103 could be moveable relative to one another by a combination of rotational and linear movement, for example, by a screw thread. In addition, any suitable number, arrangement and shapes of apertures may be provided.

Thus, according to the invention, the aerosol generating system includes flow control means for adjusting the size of at least one air inlet so as to control the air flow speed in the air flow route through the aerosol generating system. Embodiments of the aerosol generating system and flow control means have been described with reference to FIGS. 2 to 5.

1. An aerosol generating system, comprising an aerosol generating device in cooperation with a cartridge, the system configured to heat an aerosol-forming substrate and comprising:
a vaporizer configured to heat the aerosol-forming substrate to form an aerosol;
at least one air inlet;
at least one air outlet, the air inlet and the air outlet being arranged to define an air flow route between the air inlet and the air outlet; and
a flow control configured to adjust a size of the at least one air inlet, so as to control an air flow speed in the air flow route,
wherein the flow control comprises: a first member and a second member, the first and second members cooperating to define the at least one air inlet, wherein the first and second members are arranged to move relative to one another so as to vary the size of the at least one air inlet, and wherein the cartridge includes the first member and the aerosol generating device includes the second member.

2. The aerosol generating system according to claim 1, wherein the first member comprises at least one first aperture and the second member comprises at least one second aperture, the first and second apertures together forming the at least one air inlet, and wherein the first and second members are arranged to move relative to one another so as to vary the extent of overlap of the first aperture and the second aperture so as to vary the size of the at least one air inlet.

3. The aerosol generating system according to claim 1, wherein the first member and the second member are rotatably moveable relative to one another.

4. The aerosol generating system according to claim 1, wherein the first member and the second member are linearly moveable relative to one another.

5. The aerosol generating system according to claim 1, wherein the aerosol-forming substrate is a liquid aerosol-forming substrate.

6. The aerosol generating system according to claim 5, wherein the vaporizer of the aerosol generating system comprises a capillary wick configured to convey the aerosol-forming substrate by capillary action.

7. The aerosol generating system according to claim 1, wherein the aerosol generating system is electrically operated and the vaporizer of the aerosol generating system comprises an electric heater configured to heat the aerosol-forming substrate.

8.-13. (canceled)

14. A method for varying air flow speed in an aerosol generating system comprising an aerosol generating device in cooperation with a cartridge, the aerosol generating system comprising a vaporizer configured to heat an aerosol-forming substrate to form an aerosol, at least one air inlet defined between the cartridge and the aerosol generating device, and at least one air outlet, the air inlet and the air outlet being arranged to define an air flow route between the air inlet and the air outlet, the method comprising:
moving a first member of the cartridge relative to a second member of the aerosol generating device to adjust a size of the at least one air inlet, so as to vary an air flow speed in the air flow route.

15. The method according to claim 14, wherein the first member comprises at least one first aperture and the second member comprises at least one second aperture, the first and second apertures together forming the at least one air inlet, and wherein the first and second members are arranged to move relative to one another so as to vary the extent of overlap of the first aperture and the second aperture so as to vary the size of the at least one air inlet.
